(19) United States
(12) Patent Application Publication
(10) Pub. No.: US 2011/0169392 A1
(43) Pub. Date: Jul. 14, 2011

(54) LED PROJECTION LAMP

(75) Inventors: CHIEN-YUAN CHEN, TAIPEI CITY (TW); YI-SHENG CHEN, TAIPEI CITY (TW); YING-TE CHUANG, KAOHSIUNG CITY (TW)

(73) Assignee: POWER DATA COMMUNICATIONS CO., LTD., TAIPEI COUNTY (TW)

(21) Appl. No.: 12/871,224

(22) Filed: Aug. 30, 2010

(30) Foreign Application Priority Data
Jan. 8, 2010 (TW) 099200309

(51) Int. Cl. H01J 61/52; H01J 5/48

(52) U.S. Cl. 313/46; 313/318.01

(57) ABSTRACT

A light emitting diode (LED) projection lamp includes a lamp body and a plurality of LEDs. The lamp body includes an inverted conical shaped external cover, an electric contact base formed at the tip of the external cover, and a plurality of protrusions arranged on an internal wall of the external cover with a circular distribution, and each protrusion has at least one fixing surface. The LEDs are installed separately on each fixing surface, and an inclination is formed between lights emitted by the LEDs and a projection plane for reducing reflective lights, and the LEDs are electrically coupled to the electric contact base, such that heat produced by using the LEDs is conducted directly to the external cover for its dissipation to improve the heat dissipating efficiency and lifespan of the lamp, and the angular arrangement of the LEDs also improves the saturation and reflection of the light.

### CROSS-REFERENCE TO RELATED APPLICATIONS

This non-provisional application claims priority under 35 U.S.C. §119(a) on Patent Application No(s). 099200309 filed in Taiwan, R.O.C. on Jan. 8, 2010, the entire contents of which are hereby incorporated by reference.

### BACKGROUND OF THE INVENTION

1. Field of the Invention

The present invention relates to a projection illumination technology, and more particularly to a light emitting diode (LED) projection lamp structure having a plurality of LEDs installed in a three-dimensional (3D) arrangement in an external cover to produce saturated lights.

2. Description of the Related Art

Although a conventional halogen light bulb of 110 volts is a projection lamp generally used for illuminations or product exhibitions and has the advantage of a high brightness, yet its high power consumption and easiness of generating heat cause a very short lifespan. Therefore, a light emitting diode (LED) is usually used as a light source of an LED projection lamp due to the advantages of its low heat generation, low power consumption, and long lifespan.

With reference to FIG. 1 for a schematic structural view of a conventional LED projection lamp, the LED projection lamp 10 comprises an external cover 11, a voltage converter 12, and a plurality of LEDs 13, wherein an electric contact portion 111 is formed at an end of the external cover 11, and the voltage converter 12 is installed in the electric contact portion 111 and electrically coupled to the electric contact portion 111, and the LEDs 13 are arranged on a plane, disposed at the center of the external cover 11 and electrically coupled to the voltage converter 12. When use, the voltage converter 12 is provided for converting an alternate current (AC) into a direct current (DC), and the DC is supplied to the LEDs 13 for emitting light to achieve the projection effect.

However, the heat generated by the operation of the LEDs 13 is conducted indirectly to the external cover 11 and dissipated to the outside through the external cover 11 or a heat dissipating fin 112, and thus the heat dissipating effect is poor. Furthermore, the heat resistance of the LEDs 13 is low, so that the brightness of the LEDs 13 will be reduced or even the lifespan of the LEDs 13 will be shortened if the heat dissipation is poor. The light projection angle of the LED 13 of the LED projection lamp 10 is perpendicular to the projection plane, not only having a too-concentrated brightness, but also having a non-uniform brightness. A user's eyes may be irritated by the reflected light and the non-uniform brightness of the light caused by the reflection problem of the projection plane, and eye diseases may even result.

### SUMMARY OF THE INVENTION

In view of the shortcomings of the prior art, it is a primary objective of the invention to provide an LED projection lamp structure to improve the heat dissipating efficiency and extend the lifespan of the LED projection lamp, and the angular arrangement of the LEDs improve the saturation and reflection problem of the projected light significantly.

To achieve the foregoing objectives, the present invention provides an LED projection lamp comprising: a lamp body, including an inverted conical shaped external cover, an electric contact base disposed at the tip of the external cover, and a plurality of protrusions formed on an internal wall of the external cover and arranged on at least one circular shaped distribution, and at least one fixing surface formed at the middle of each protrusion, and each fixing surface having a predetermined angle; and a plurality of LEDs, separately installed on each fixing surface, and electrically coupled to the electric contact base, and an inclination being formed between a light emitted by the LEDs and a projection plane for reducing a reflective light, and the projected light being concentrated at the center of the lamp body.

In addition, a layer of heat dissipating coating is coated on a surface of the external cover, such that the heat generated by the operation of the LEDs can be conducted to the external cover directly and quickly to improve the heat dissipating efficiency and extended the lifespan effectively.

In a preferred embodiment, the protrusions are protruding bump structures or arc bump structures, and the protrusions are concentrically arranged with one or more circular distributions on an internal wall of the external cover. In addition, a fixing surface of the protrusion has a predetermined angle of 35-85 degrees with respect to the horizontal plane. After the LEDs are installed at the protrusions, the projected light is inclined with respect to the projection plane and concentrated at the center of the lamp body to overcome the light saturation and reflection problems.

In a preferred embodiment, an opening is formed at another end opposite to the tip of the external cover, and the opening further includes a transparent decorative cover installed therein for resisting water and dusts.

In a preferred embodiment, the electric contact base further includes an external thread and an electric contact portion, or an electric contact portion formed at an end of the electric contact base and two symmetric latch portions formed at the periphery of the electric contact base, or screwed or latched into the lamp base for accessing electricity to provides a convenient application.

### BRIEF DESCRIPTION OF THE DRAWINGS

FIG. 1 is a schematic structural view of a conventional LED projection lamp;

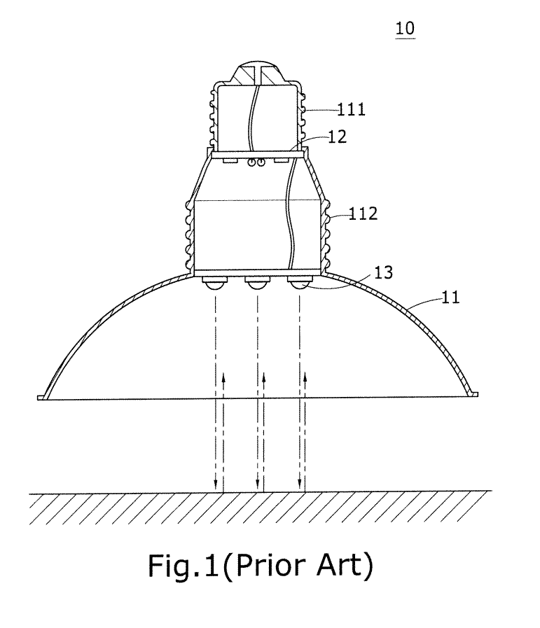

FIG. 2 is a schematic structural view of a preferred embodiment of the present invention;

FIG. 3 is a schematic structural view of an application in accordance with a preferred embodiment of the present invention;

FIG. 4 is a schematic structural view of another preferred embodiment of the present invention; and

FIG. 5 is a schematic view of an electric contact base in accordance with another preferred embodiment of the present invention.

### DETAILED DESCRIPTION OF THE PREFERRED EMBODIMENTS

To make it easier for our examiner to understand the technical contents of the present invention, preferred embodiments together with related drawings are used for the detailed description of the present invention as follows.

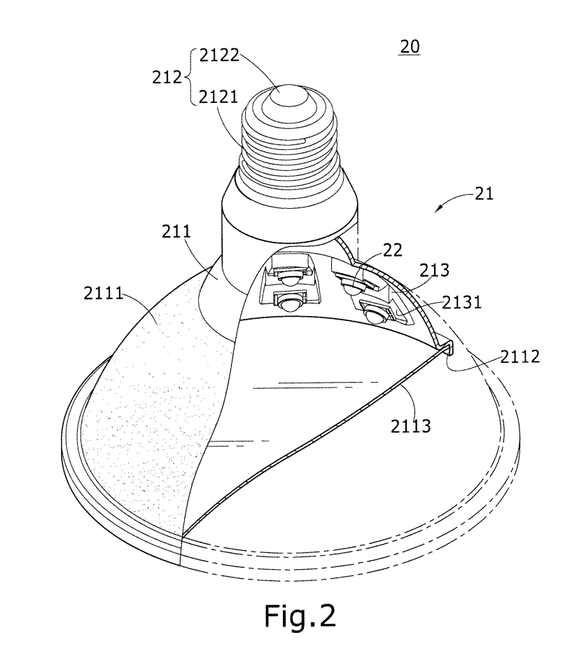

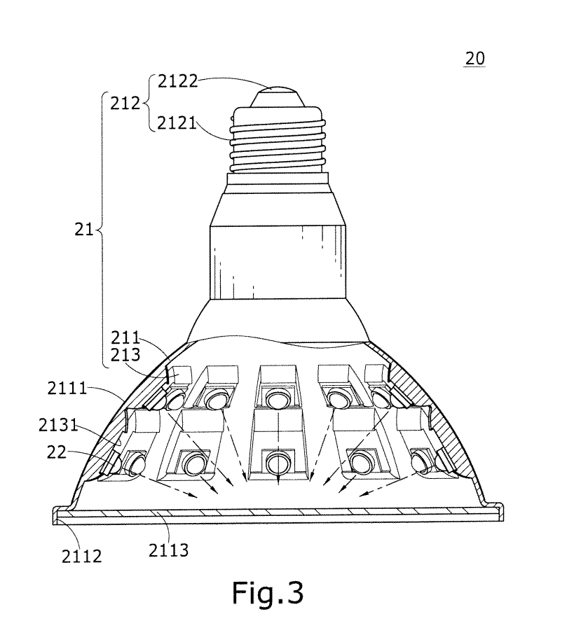

With reference to FIGS. 2 to 4 for a schematic structural view of a preferred embodiment, a schematic view of an application, and a schematic structural view of another preferred embodiment in accordance with the present invention respectively, an LED projection lamp 20 is electrically coupled to a lamp base (not shown in the figures) for the use of the LED projection lamp 20, and the LED projection lamp 20 comprises a lamp body 21 and a plurality of LEDs 22.

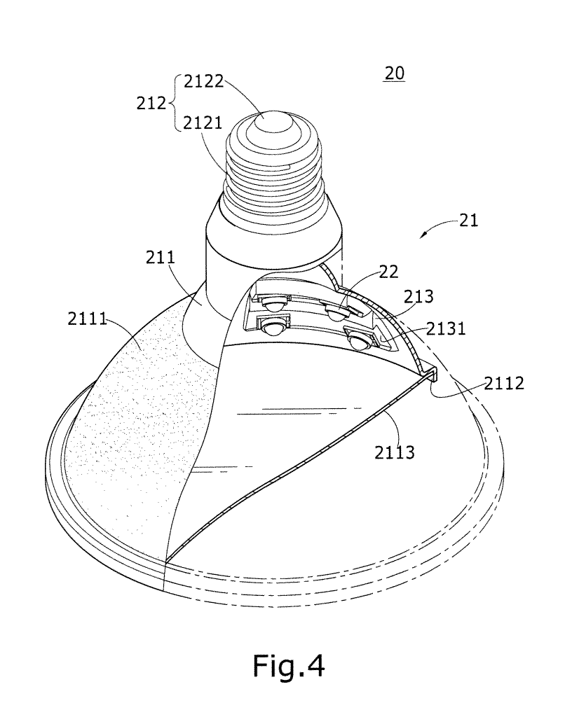

The lamp body 21 includes an inverted conical shaped external cover 211, a layer of heat dissipating coating 2111 coated on a surface of the external cover 211, an opening 2112 formed at another end opposite to the tip of the external cover 211, and a transparent decorative cover 2113 installed in the opening 2112. In FIG. 2, an electric contact base 212 is formed at the tip of the external cover 211, and an external thread 2121 and an electric contact portion 2122 are formed at the electric contact base 212 and provided for being screwed into the lamp base for accessing electricity. In addition, the external cover 211 includes a plurality of protrusions 213 formed on an internal wall of the external cover 211 (as shown in FIG. 2, wherein the protrusions 213 are protruding bump structures integrally formed inside the external cover 211; or as shown in FIG. 4, wherein the protrusions 213 are arc protruding bump structures integrally formed inside the external cover 211), and the protrusions 213 are concentrically arranged into one or more circular distributions, and each protrusion 213 includes at least one fixing surface 2131 at the center of the protrusion 213, and each fixing surface 2131 comes with a predetermined angle, and the predetermined angle of the fixing surface 2131 with respect to the horizontal plane falls in a range from 35 degrees to 85 degrees.

The LEDs 22 are mounted onto the fixing surfaces 2131 respectively, and electrically coupled to the electric contact base 212, such that the projected light of the LEDs 22 has an inclination with respect to a projection plane and concentrated at the center of the lamp body 21, such that the heat generated by the operation of the LEDs 22 can be conducted to the external cover 211 through the protrusions 213 directly and quickly. This arrangement not only reduces the manufacturing cost by using a larger heat dissipating area to substitute the heat dissipating fin, but also improving the heat dissipating efficiency by the heat dissipating coating 2111 of the external cover 211, so as to extend the lifespan of the LEDs 22 and prevent the reduction of brightness. In addition, the LEDs 22 are installed with an angle with respect to the fixing surface 2131, such that lights emitted by the LEDs 22 is projected in three dimensionally in all directions from the external cover 211, and the LED projection lamp 20 can have a projection brightness with a better saturation. Since there is an inclination between the projected light and the projection plane, discomfort to the eyes caused by the linearly reflected lights can be avoided.

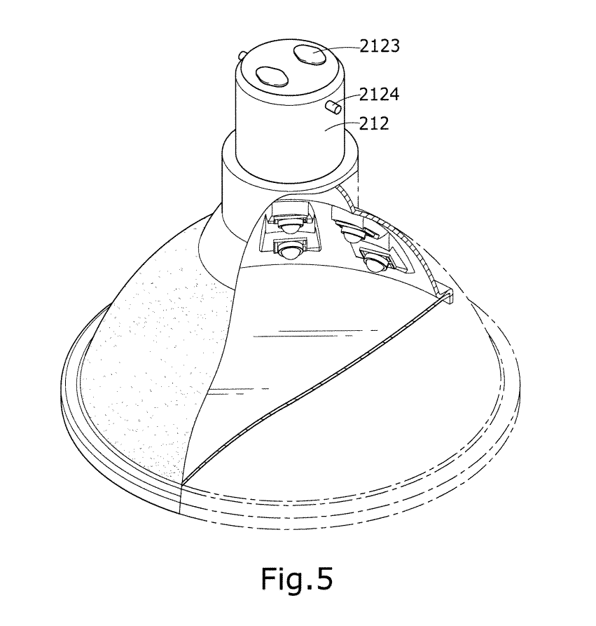

With reference to FIG. 5 for a schematic view of an electric contact base in accordance with another preferred embodiment of the present invention, another type of electric contact bases 212 can be used for electrically connecting the lamp base, wherein its structure is described as follows. The electric contact base 212 includes an electric contact portion 2123 formed at an end of the electric contact base 212, and two symmetric latch portions 2124 formed at the periphery of the electric contact base 212 and provided for being latched into the lamp base for accessing electricity, and other structures are the same as the aforementioned preferred embodiment and thus will not be described here again.

As illustrated in the preferred embodiments as shown in FIGS. 2 to 4, the present invention has the following advantages:

1. The LEDs 22 of the present invention are mounted directly inside the external cover 211 of the lamp body 21, such that the heat generated by the LEDs 22 can be conducted directly for the heat dissipation, and the heat dissipating coating is coated onto the external cover 211 to achieve the effects of improving the heat dissipating efficiency and extending the lifespan.

2. Since the plurality of protrusions 213 are formed on the internal wall of the external cover 211 and the fixing surface 2131 of the protrusions 213 comes with an angle, therefore the LED projection lamp 20 can produce a 3D projection effect, and the inclination between the projected light and the projection plane can improve the saturation and reflection problems of the projected light.

In summation of the description above, the present invention can improve over the prior art and comply with the patent application requirements, and thus the invention is duly filed for patent application. While the invention has been described by device of specific embodiments, numerous modifications and variations such as the color, power and quantity of the LEDs, or the type and size of the external cover, or even the quantity and arrangement of the protrusions could be made thereto by those generally skilled in the art without departing from the scope and spirit of the invention set forth in the claims.

What is claimed is:

1. A light emitting diode (LED) projection lamp, electrically coupled to a lamp base for using the LED projection lamp, and comprising:
a lamp body, including an inverted conical shaped external cover, an electric contact base disposed at the tip of the external cover, and a plurality of protrusions formed on an internal wall of the external cover and arranged on at least one circular shaped distribution, and at least one fixing surface formed at the middle of each protrusion, and each fixing surface having a predetermined angle; and
a plurality of LEDs, separately installed on each fixing surface, and electrically coupled to the electric contact base, and an inclination being formed between a light emitted by the LEDs and a projection plane for reducing a reflective light, and the projected light being concentrated at the center of the lamp body.

2. The LED projection lamp of claim 1, wherein the protrusion is a protruding bump structure.

3. The LED projection lamp of claim 1, wherein the protrusion is an arc bump structure.

4. The LED projection lamp of claim 1, wherein the fixing surface is inclined at the predetermined angle of substantially 35 to 85 degrees with respect to the horizontal plane.

5. The LED projection lamp of claim 2, wherein the fixing surface is inclined at the predetermined angle of substantially 35 to 85 degrees with respect to the horizontal plane.

6. The LED projection lamp of claim 3, wherein the fixing surface is inclined at the predetermined angle of substantially 35 to 85 degrees with respect to the horizontal plane.

7. The LED projection lamp of claim 1, wherein the protrusions are concentrically arranged on a multi-circular distribution.

8. The LED projection lamp of claim 2, wherein the protrusions are concentrically arranged on a multi-circular distribution.

9. The LED projection lamp of claim 3, wherein the protrusions are concentrically arranged on a multi-circular distribution.

10. The LED projection lamp of claim 1, wherein the external cover further includes a layer of heat dissipating coating coated on a surface of the external cover.

11. The LED projection lamp of claim 2, wherein the external cover further includes a layer of heat dissipating coating coated on a surface of the external cover.

12. The LED projection lamp of claim 3, wherein the external cover further includes a layer of heat dissipating coating coated on a surface of the external cover.

13. The LED projection lamp of claim 1, wherein the electric contact base further includes an external thread and an electric contact portion, provided for being screwed into the lamp base for accessing electricity.

14. The LED projection lamp of claim 2, wherein the electric contact base further includes an external thread and an electric contact portion, provided for being screwed into the lamp base for accessing electricity.

15. The LED projection lamp of claim 3, wherein the electric contact base further includes an external thread and an electric contact portion, provided for being screwed into the lamp base for accessing electricity.

16. The LED projection lamp of claim 1, wherein the electric contact base includes an electric contact portion formed at an end of the electric contact base, and two symmetric latch portions formed at the periphery of the electric contact base, and provided for being latched into the lamp base for accessing electricity.

17. The LED projection lamp of claim 2, wherein the electric contact base includes an electric contact portion formed at an end of the electric contact base, and two symmetric latch portions formed at the periphery of the electric contact base, and provided for being latched into the lamp base for accessing electricity.

18. The LED projection lamp of claim 3, wherein the electric contact base includes an electric contact portion formed at an end of the electric contact base, and two symmetric latch portions formed at the periphery of the electric contact base, and provided for being latched into the lamp base for accessing electricity.
